(19) United States
(12) Patent Application Publication
(10) Pub. No.: US 2007/0251554 A1
(43) Pub. Date: Nov. 1, 2007

(54) Device for Cleaning Electronic, Audiovisual and Computing Equipment Display Screens and Keyboards

(76) Inventor: Ricard Domenech Sague, Barcelona (ES)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/598,438

(22) PCT Filed: Feb. 7, 2005
(86) PCT No.: PCT/ES05/00052

§ 371 Date: Jun. 5, 2007

(30) Foreign Application Priority Data
Mar. 2, 2004 (ES) P200400489

(51) Int. Cl. B08B 1/00

(52) U.S. Cl. 134/59

(57) ABSTRACT

The invention relates to a device for cleaning electronic, audiovisual and computing equipment display screens and keyboards comprising a main body (1), a display screen cleaning head (21), a first extraction/retraction mechanism suitable for extracting and/or introducing the display screen cleaning head (21) into said main body (1), a brush (43) and a second extraction/retraction mechanism suitable for extracting and/or introducing the brush (43) into said main body (1). The first extraction/retraction mechanism preferably comprises an extractable arm and a head support (23) rotatable about the outer end of the extractable arm, and the brush (43) is shaped to allow its insertion between the keys of the keyboard.

### FIELD OF THE INVENTION

The invention relates to a device for cleaning electronic, audiovisual and computing equipment display screens and keyboards.

### STATE OF THE ART

The use of electronic, audiovisual and/or computing equipment having both a display screen and keyboard is common today. The clearest example are computers, but there is also other equipment such as television sets with a teletext keyboard, portable telephones and faxes, PDAs etc. having both a display screen and a keyboard. This equipment is usually cleaned with cleaning elements not specifically designed for them, which makes cleaning them more difficult. In addition, the cleaning elements are usually stored in locations normally far from where the equipment is located; as a result, the equipment is usually cleaned sporadically and incompletely. Nor is it uncommon that when the display screen is cleaned inappropriately it causes damages, usually scratches which damage it and deteriorate the image quality.

### SUMMARY OF THE INVENTION

The object of the invention is to overcome these drawbacks. This is achieved by means of a device for cleaning electronic, audiovisual and computing equipment display screens and keyboards characterized in that it comprises a main body, a display screen cleaning head, a first extraction/retraction mechanism suitable for extracting and/or introducing said display screen cleaning head into said main body, a brush and a second extraction/retraction mechanism suitable for extracting and/or introducing said brush into said main body.

A device of this type effectively allows combining the cleaning of two basic elements of the previously mentioned electronic, computing and/or audiovisual equipment: on one hand the display screen, which requires very frequent cleaning and is very sensitive to dust accumulation, to becoming dirty when touched by fingers, etc., and on the other hand the keyboard, which is very hard to clean unless a brush is used given that the dirt that accumulates between the keys and on the bottom of the keyboard cannot be removed by means of using a conventional dust cloth.

The device according to the invention additionally solves another common problem with cleaning tools, consisting in that they become dirty on their own because of the mere fact that they are not stored inside a closed box. This is particularly important for both the display screen cleaning head, because cleaning display screens must always be done with an element that is very clean, and for the brush, because its very hair-like structure makes it predisposed to accumulating dirt around them. With the device according to the invention the main body itself is a case for the cleaning elements (the display screen cleaning head and brush) such that the cleaning elements are always perfectly stored and protected from dirt until the moment they are used.

Another advantage of the invention is that when the device has the cleaning elements retracted (both the display screen cleaning head and the brush), it is of a size approximately similar to standard desk tools, so it can be stored together with the desk tools such that it is always on hand. It can also be easily carried given its compact size.

The display screen cleaning head preferably has an elongated structure, advantageously about 60 mm in length, which facilitates cleaning a large and substantially planar surface such as a display screen, and is preferably arranged substantially perpendicular to the axis of the main body because it is the most ergonomic shape. The first extraction/retraction mechanism advantageously comprises an extractable arm and a head support rotatable around the outer end of said extractable arm. Effectively, it is thus possible to share the advantage that the display screen cleaning head has an elongated structure and perpendicular to the axis of the main body, with the advantage that the device can be folded so that it takes up minimum space when it is not being used and is protected from dirt inside the device itself.

The first extraction/retraction mechanism preferably comprises a rectilinear runner arranged in the support or in the extractable arm and a lug arranged respectively in the extractable arm or in the support, this lug being suitable for being housed in the rectilinear runner. A particularly simple and effective rocking mechanism is thus effectively obtained for the display screen cleaning head as will be seen more clearly below in the embodiment examples.

The display screen cleaning head advantageously comprises a cleaning element completely wrapped in a cleaning material and having a recess that allows housing the head support inside it. Any contact of a hard material with the screen is thus effectively prevented because the entire contact surface of the display screen cleaning head with the display screen is completely wrapped up in the cleaning material. This material preferably comprises a lay of foamy material and a layer of polyester microfiber knit fabric. The display screen cleaning head is advantageously an elongated prismatic body of triangular cross-section. Thus, it can be applied on the display screen by one of the sides of the triangular prismatic surface, which allows exerting very slight pressure on the display screen, or by the edge formed by the joining of two of the sides of the triangular prismatic surface, which allows exerting greater pressure if it is needed. Another preferred geometry of the head is the semi-cylindrical body because in this case any support angle results in a contact of a softly rounded surface on the display screen.

A preferred embodiment of the invention is obtained when the first extraction/retraction mechanism comprises a first half-arm with a first projection, a second half-arm with a second projection, where the first half-arm and the second half-arm form the extractable arm, a cylindrical body suitable for housing the first and second half-arms inside it and with two longitudinal grooves suitable for being traveled through by the first and second projections, where the first and second projections extend beyond the cylindrical body, and a tube suitable for housing the cylindrical body inside it and with two helical grooves suitable for being traveled through by the first and second projections. This embodiment allows obtaining a device according to the invention that is very compact, simple and economical.

Another preferred embodiment of the invention is obtained when the first extraction/retraction mechanism comprises a first half-arm, a second half-arm, where the first half-arm and the second half-arm form the extractable arm, a tube suitable for housing the extractable arm inside it and defining a longitudinal axis, a spring joined at its ends to the first and second half-arms and suitable for shifting the second half-arm with respect to the first half-arm in the direction of the longitudinal axis between a first stop and a second stop, a limiting stop and a guide element suitable for being shifted longitudinally along the tube.

The guide element is preferably joined to the extractable arm and the brush simultaneously.

The brush is advantageously shaped and preferably comprises a central area projecting between 10 and 20 mm and a width between 1 and 4 mm. Accessing spaces between the keys is obtained with this geometry on the vast majority of conventional keyboards without needing to cause any deformation of the remaining hairs of the brush.

### BRIEF DESCRIPTION OF THE DRAWINGS

Other advantages and features of the invention can be seen from the following description in which preferred embodiments of the invention are described without any limiting nature, mentioning the attached drawings. In the drawings:

FIG. 1 shows an assembly scheme of a first embodiment of the invention,

FIG. 2 shows a first partial cross-section view of the main body of the first embodiment of FIG. 1,

FIG. 3 shows a second partial cross-section view of the main body of the first embodiment of FIG. 1,

FIG. 4 shows a third partial cross-section view of the main body of the first embodiment of FIG. 1,

FIGS. 5 to 8 show plan views of a rotating mechanism for the display screen cleaning head,

FIG. 9 shows a perspective view of a head support,

FIG. 10 shows a plan view of the head support of FIG. 9,

FIG. 11 shows an elevational view of the head support of FIG. 9,

FIG. 12 shows a perspective view of a cleaning element,

FIG. 13 shows an assembly scheme of a second embodiment of the invention,

FIG. 14 shows a side elevational view of a guide element,

FIG. 15 shows a cross-section view of the guide element of FIG. 14,

FIG. 16 shows a front elevational view of the guide element of FIG. 14,

FIG. 17 shows an upper perspective view of a first half-arm,

FIG. 18 shows a lower perspective view of the first half-arm of FIG. 17,

FIG. 19 shows an upper perspective view of a second half-arm,

FIG. 20 shows a plan view of the second half-arm of FIG. 19,

FIG. 21 shows a plan view of the spring arranged between both half-arms,

FIG. 22 shows a perspective view of the device of FIG. 13 with the brush extracted,

FIG. 23 shows a perspective view of the device of FIG. 13 with the display screen cleaning device extracted.

### DETAILED DESCRIPTION OF EMBODIMENTS OF THE INVENTION

Two possible embodiments of the invention will be described below by way of example.

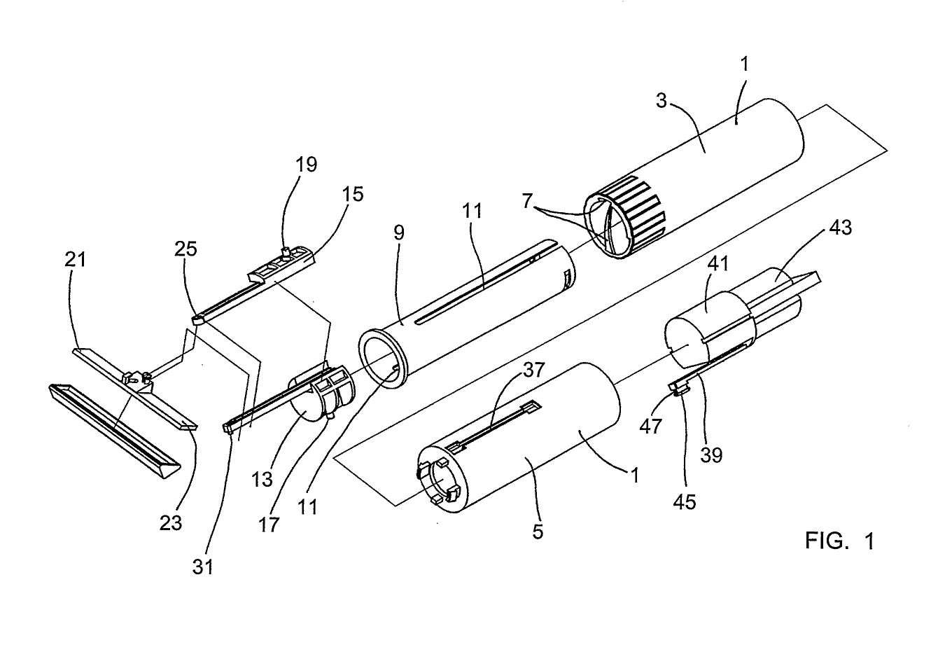

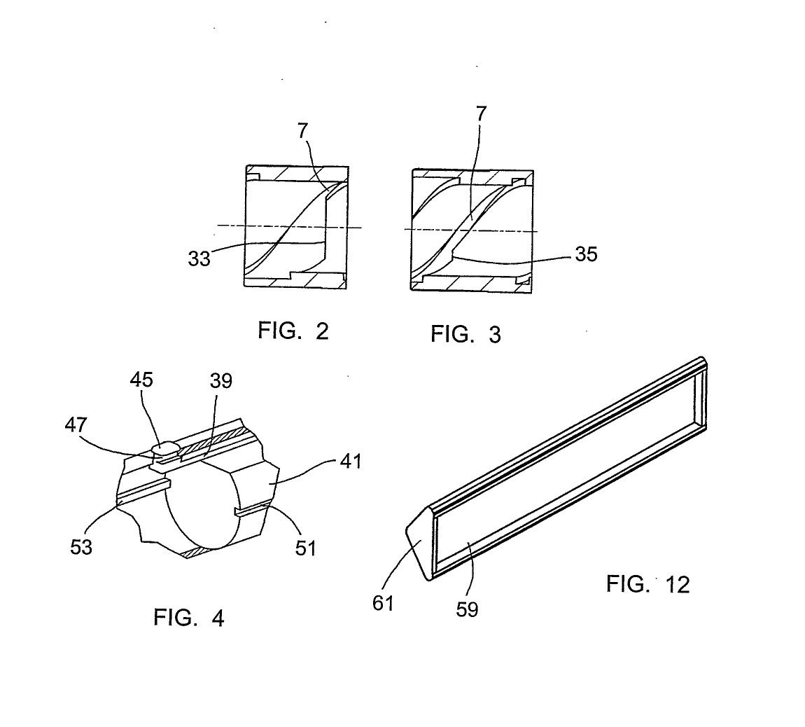

A first embodiment of the invention is the one shown in FIG. 1. The device has a main body 1 formed by two half-bodies 3 and 5. The first half-arm 3 is substantially a cylindrical tube, inside of which it has two helical grooves 7. A cylindrical body 9 having two longitudinal grooves 11 is housed inside the first half-body 3. A first half-arm 13 and a second half-arm 15 are housed inside the cylindrical body 9. The first half-arm 13 has a first projection 17 and the second half-arm 15 has a second projection 19. When both half-arms 13 and 15 are assembled inside the cylindrical body 9, the projections 17 and 19 traverse the longitudinal grooves 11 and project from the same, so that the ends of the projections 17 and 19 are housed inside the helical grooves 7. The cylindrical body 9 is fixed, for example by snap-fitting, to the second half-body 5. In this way the user can take the device with his/her hand by the second half body 5 and can make the first half-body 3 rotate with respect to the cylindrical body 9. By carrying out this rotation the projections 17 and 19 are forced to shift along the helical grooves 7, which causes both half-arms 13 and 15 to shift in the axial direction. In this way, by means of rotating the first half-body 3 the movements for extracting and retracting a display screen cleaning head 21 which is joined to the end of the half-arms 13 and 15 can be carried out.

The joining of the display screen cleaning head 21 to the end of the half-arms 13 and 15 is carried out such that a relative movement between both half-arms 13 and 15 allows the rotation of the display screen cleaning head 21. The display screen cleaning head 21 effectively comprises a head support 23 that is joined to one of the half-arms, for example to the second half-arm 15, through an orifice 25 arranged in the second half-arm 15. To that end the head support 23 has a grooved projection 27 the free end of which is flared so that it can be introduced in the orifice 25 and be retained therein by a snap-fitting effect. The head support 23 can thus rotate about the projection 27. The head support 23 also has a rectilinear runner 29 whereas the first half-arm 13 has a lug 31 suitable for being housed in the rectilinear runner 29. When both half-arms 13 and 15 are shifted together, the head support 23 shifts together with the half-arms 13 and 15 but does not rotate about it because the lug 31 retains it in a certain position. However, if a relative shifting is carried out between both half-arms 13 and 15, then the lug 31 forces the head support 23 to rotate about the projection 27.

This relative movement between both half-arms 13 and 15 is achieved by means of a suitable design of the helical grooves 7. The initial sections of the helical grooves 7 effectively are equal to one another, which causes the simultaneous and synchronous shifting between both half-arms 13 and 15. However, one of the helical grooves 7 is of less total length than the other one and has a first planar section 33, so that the corresponding half-arm does not axially shift when its projection reaches this first planar section 33. In turn the other helical groove 7 continues to force the shifting of the other half-arm thus obtaining the relative shifting between both half-arms until it reaches a second planar section 35 corresponding to the end of travel of the extraction/retraction mechanism of the display screen cleaning head.

In turn the second half-body 5 has a third longitudinal groove 37 with two flares at its ends so that a guide arm 39 for a guide element forming a base 41 of a brush 43 can shift along the third groove 37. The guide arm 39 has a button 45 at its end with an intermediate neck 47. The guide arm 39 is flexible so that it can be slightly pressed towards the inside of the second half-body 5 so that the neck 47 is opposite the third groove 37 and can be shifted along it. The guide arm 39 preferably has a thickness that is gradually reduced from a maximum value at the point of joining to the base 41 to a minimum value at the end of the button 45.

The base 41 advantageously includes side grooves 51 that fit with guides 53 arranged inside the second half-body 5 to improve guiding the base 41 through the inside of the first half-body 5.

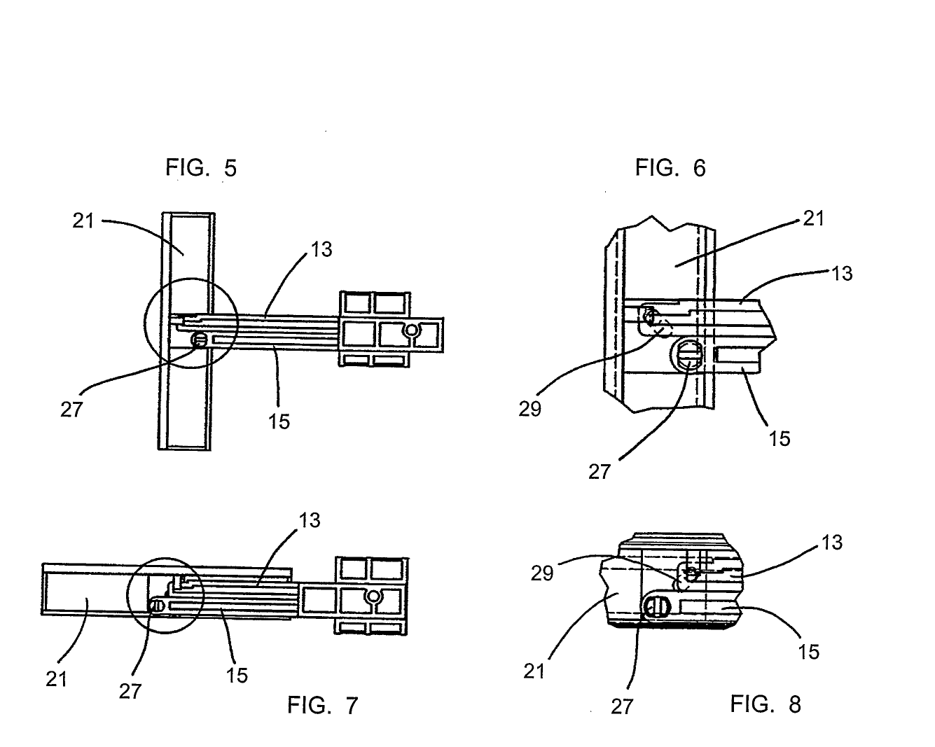

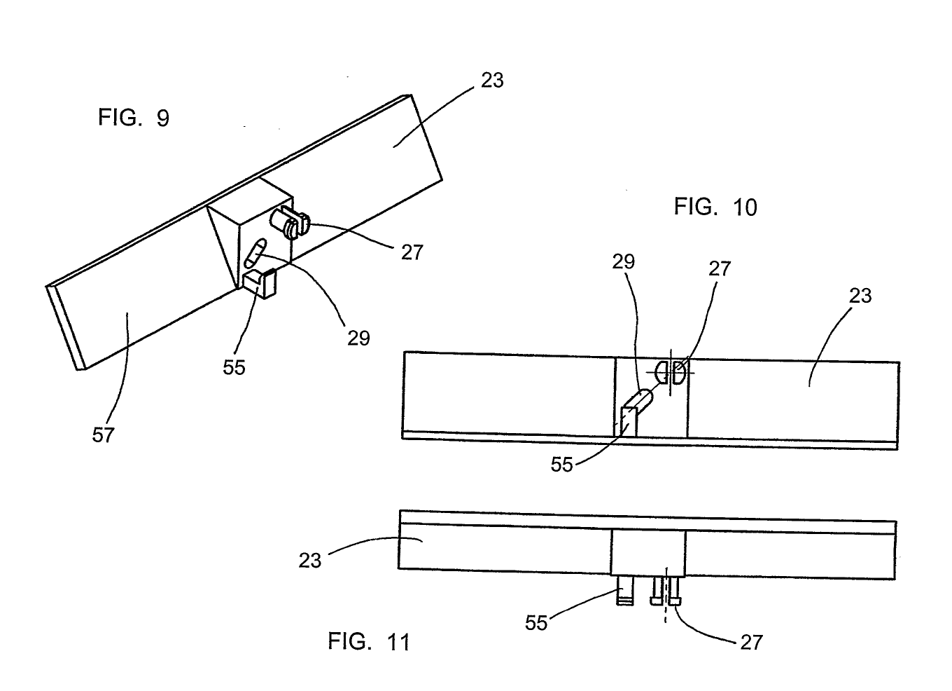

FIGS. 5 to 8 show the end positions of the display screen cleaning head 21. FIG. 5 (and FIG. 6, which corresponds to an enlargement of the central part of FIG. 5) shows the display screen cleaning head 21 in the extended position. The first half-arm 13 and the second half-arm 15 are in a certain relative position. When initiating the retraction movement (which is symmetrical to the extraction movement) the first half-arm 13 moves first, in this way the lug 31 forces the head support 23 to rotate about the projection 27, whereas the lug 31 shifts along the rectilinear runner 29. FIG. 7 (and FIG. 8, which corresponds to an enlargement of the central part of FIG. 7) shows the display screen cleaning head 21 completely folded. After this time both half-arms 13 and 15 will shift simultaneously, thus introducing the display screen cleaning head 21 inside the first half-body 3.

The head support 23 further has a stop 55 limiting the rotation thereof. The head support 23 has a rectangular surface 57 which is completely housed inside a recess 59 provided with a cleaning element 61. The cleaning element 61 is completely wrapped up in a cleaning material and thus prevents contact of any material that is not said cleaning material with the display screen. The cleaning element 61 is substantially an elongated prismatic body of triangular cross-section. The mentioned recess 59 is located on one of the side faces and the other two faces are opposite to the display screen so that the display screen can be cleaned with any of them and/or with the edges formed between both. The edge is advantageously rounded.

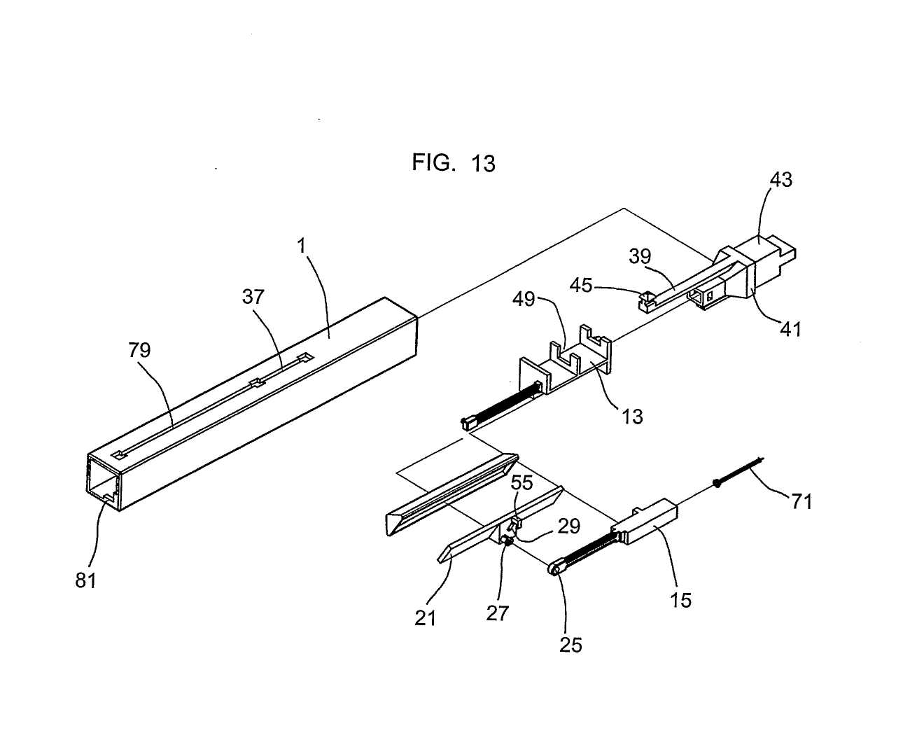

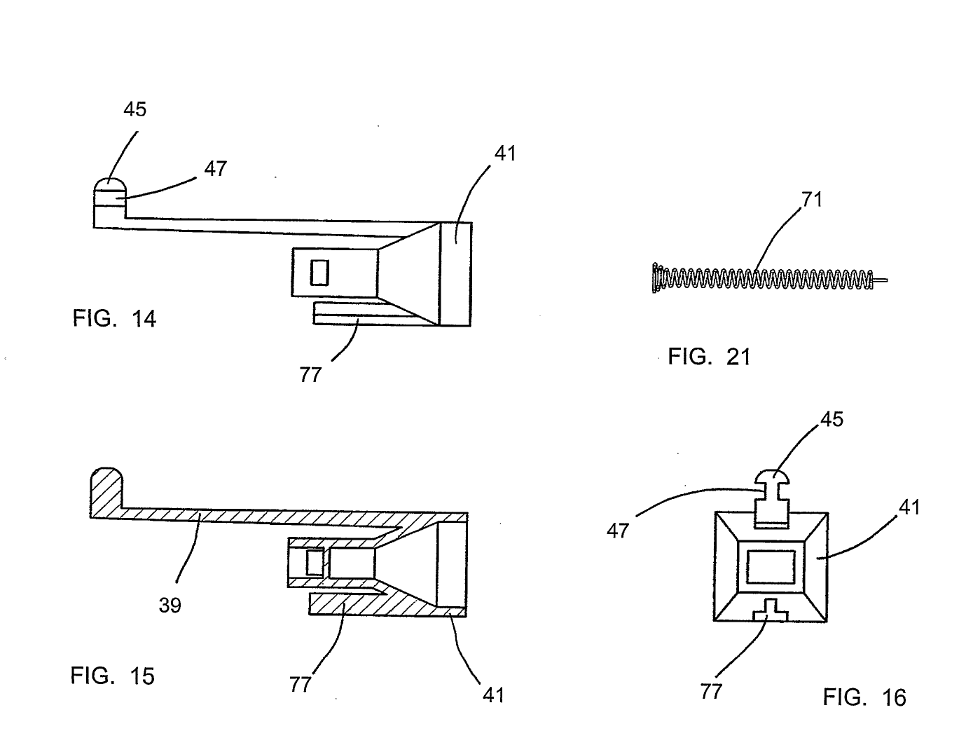

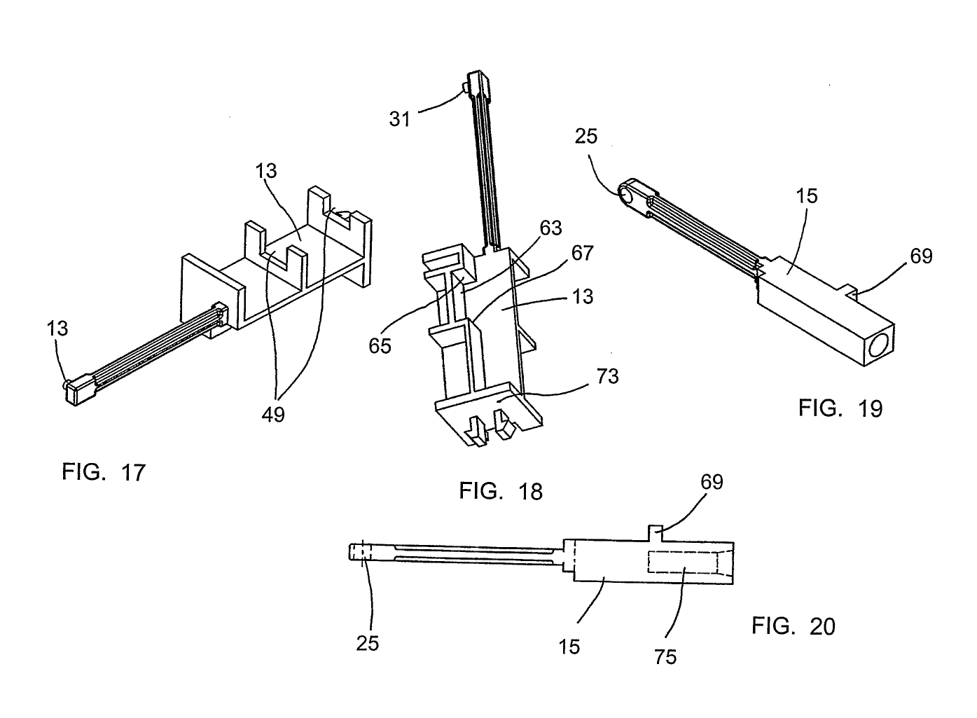

Another embodiment of the invention is schematically shown in FIG. 13. The device is conceptually equal to the former one: it comprises a main body 1, a display screen cleaning head 21, a first extraction/retraction mechanism for the display screen cleaning head 21, a brush 43 and a second extraction/retraction mechanism for the brush 43. It is all housed inside the main body 1 when it is not in use, like in the previous case. However in this case, the first extraction/retraction mechanism and the second extraction/retraction mechanism share many elements in common. In fact, as will be seen below, the shifting of the display screen cleaning head 21 involves the shifting of the brush 43 and vice versa. Another difference is based on the fact that the movements involved are all translational movements without any rotation.

The device has a guide element which on one side is a base 41 for a brush 43 having a guide arm 39 so that the brush 43 can shift along a third groove 37 in the same way as in the previous example.

On the side opposite to the brush 43, the guide element, or the base 41, is joined to a first half-arm 13. A second half-arm 15 is arranged next to the first half-arm 13 and can be moved with respect to the first half-arm 13 between two positions demarcated by a cavity 63 defining two stops (65, 67) and is traveled through by a second projection 69 arranged in the second half-arm 15. Assembled between the first half-arm 13 and the second half-arm 15 there is a compression spring 71. The spring 71 is fixed to the first half-arm 13 through a fixing orifice 73. The opposite end of the spring 71 is housed in a blind orifice 75 of the second half-arm 15 having a beveled entrance. The end of the spring 71 housed at the bottom of this blind orifice 75 has a larger diameter, which allows better centering of the spring 71 in the blind orifice 75 and a reduction of the friction between the spring 71 and the walls of the blind orifice 75.

The guide arm 39 extends from the base 41 in the direction opposite to that of the hairs of the brush 43, i.e. it extends adjacent to the extractable arm so the area of the extractable arm that is next to the guide arm 39 preferably has a hollow space 49 which allows housing the guide arm 39 inside it. This allows a particularly compact construction of the device.

Preferably extending on the side diametrically opposite to the point of joining between the base 41 and the guide arm 39 there is a compensating surface 77 which compensates for the torque introduced by the actuation of the guide arm 39, which facilitates smoother guiding.

The display screen cleaning head 21 is in principle identical to that of the previous example and the way of fixing it to the half-arms 13 and 15, as well as the way of obtaining its rotation, are also equal to the previous example. In this case, the relative shifting between both half-arms 13 and 15 is achieved in the following way. Opposite to the third groove 37 there is a fourth groove 79. This guide arm 39 can be shifted along the fourth groove 79 which causes the joint shifting of both half-arms 13 and 15 along the inside of the main body 1. The second half-arm 15 is at the end position closest to the exit of the main body 1 as a result of the spring 71 pushing it so that the second projection 69 acts as a stop against the outer end of the cavity 63. When the display screen cleaning head 21 has completely exited from inside the main body 1 the second half-arm 15 is blocked by a limiting stop 81. The first half-arm 13 can continue to be pushed outwardly but the second half-arm 15 is retained by the limiting stop 81 while the spring 71 is gradually compressed. The relative shifting between both half-arms 13 and 15 is thus obtained and the display screen cleaning head 21 rotates about the projection 27. When the retraction movement is carried out only the first half-arm 13 shifts initially because the spring 71 keeps the second half-arm 15 in contact with the limiting stop 81. When the second projection 69 of the second half-arm 15 comes into contact with the outer end of the cavity 63 of the first half-arm 13, then it is dragged together with the first half-arm 13. First the folding of the display screen cleaning head 21 and then the introduction of the display screen cleaning head 21 inside the main body 1 is thus obtained

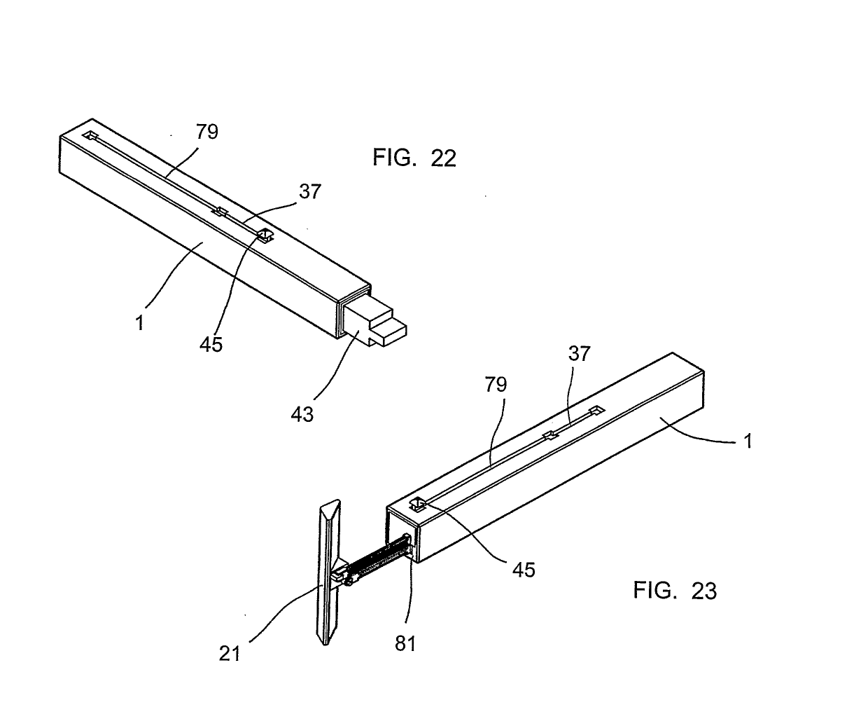

FIGS. 22 and 23 show the two end positions of the device: with the brush 43 extracted and with the display screen cleaning head 21 extracted. As can be seen, the first extraction/retraction mechanism and the second extraction/retraction mechanism are condensed in a single mechanism which, when the guide element is in a central position, both the brush 43 and the display screen cleaning head 21 are inside the main body 1, and when the guide element shifts to one side or the other, the corresponding cleaning element is extracted. Generally it can be seen that this concept can be generalized to other extraction/retraction mechanisms. So for example the rotating mechanism of the first example could have a guide element that was joined both to the half-arms 13 and 15 and to the base 41 of the brush 43. With the guide element in an intermediate position of the helical grooves 7, both cleaning elements could be concealed, and by rotating the first half-body 3 in one direction or the other, the corresponding cleaning element could be extracted.

1. A device for cleaning electronic, audiovisual and computing equipment display screens and keyboards comprising:
a main body;
a display screen cleaning head;
a first mechanism suitable for extracting and introducing said display screen cleaning head into said main body;
a brush and a second mechanism for extracting and introducing said brush into said main body, wherein said first mechanism comprising an extractable arm having an outer end, and a head support rotatable about said outer end of the extractable arm.

2. A device according to claim 1, wherein said first mechanism comprises a rectilinear runner arranged in one of said head support or said extractable arm and a lug arranged respectively in one of said extractable arm or said head support, said lug being suitable for being housed in said rectilinear runner.

3. A device according to claim 1, wherein said display screen cleaning head comprises a cleaning element completely wrapped up in a cleaning material and having a recess for housing said head support therein.

4. A device according to claim 3, wherein said cleaning material comprises a layer of foamy material and a layer of polyester microfiber knit fabric.

5. A device according to claim 1, wherein said display screen cleaning head comprises an elongated prismatic body having a generally triangular cross-section.

6. A device according to claim 1 wherein said first mechanism comprises:
a first half-arm with a first projection;
a second half-arm with a second projection, wherein said first half-arm and said second half-arm form said extractable arm,
a cylindrical body suitable for housing said first and second half-arms therein and with two longitudinal grooves (11) suitable for being traveled through by said first and second projections, wherein said first and second projections extend beyond said cylindrical body; and
a tube suitable for housing said cylindrical body therein and with two helical grooves suitable for being traveled through by said first and second projections.

7. A device according to claim 1, wherein said first mechanism comprises:
a first half-arm;
a second half-arm, wherein said first half-arm and said second half-arm form said extractable arm,
a tube suitable for housing said extractable arm inside it and defining a longitudinal axis,
a spring joined having opposite ends joined to said first and second half-arms and suitable for shifting said second half-arm with respect to said first half-arm in the direction of said longitudinal axis between a first stop and a second stop, and a limiting stop; and
a guide element suitable for being longitudinally shifted along said tube.

8. A device according to claim 7, wherein said guide element is joined to said extractable arm and to said brush simultaneously.

9. A device according to claim 1 wherein said brush is shaped.

10. A device according to claim 9, wherein said brush comprises a central area projecting between 10 and 20 mm and a width between 1 and 4 mm.

11. A device according to claim 2, wherein said display screen cleaning head comprises a cleaning element completely wrapped up in a cleaning material and having a recess for housing said head support therein.

12. A device according to claim 5, wherein said display screen cleaning head comprises an elongated prismatic body having a generally triangular cross-section.
